(19) United States
(12) Patent Application Publication
(10) Pub. No.: US 2004/0003311 A1
(43) Pub. Date: Jan. 1, 2004

(54) Data communication method

(75) Inventor: Marcus Richard Jones, Lincoln (GB)

Correspondence Address: James M. Bagarazzi, DORITY & MANNING, P.A., P.O. BOX 1449, GREENVILLE, SC, 29602-1449, US

(73) Assignee: Zarlink Semiconductor Limited

(21) Appl. No.: 10/395,025

(22) Filed: Mar. 21, 2003

(30) Foreign Application Priority Data
Mar. 22, 2002 (GB) 0206852.6

(51) Int. Cl. G06F 1/32; G06F 13/00

(52) U.S. Cl. 713/320; 713/322; 710/34

(57) ABSTRACT

A communications system comprises a PDA and a Bluetooth peripheral device. The Bluetooth peripheral device is connected to the PDA by a data channel. The Bluetooth peripheral device enables the PDA to communicate with remote data networks using the Bluetooth wireless protocol. The system is configured to operate according to an algorithm that enables the Bluetooth peripheral device to enter an ultra-low power mode in which a receiver associated with data transfer can be disabled when no data is required to be transmitted. Data loss is prevented through the use of a hardware handshake mechanism that stops the PDA from sending data while the Bluetooth peripheral device is in the low power mode. Latency in the PDA responding to a change in handshake signals is provided.

### CROSS-REFERENCE TO RELATED APPLICATIONS

The present application claims priority to currently pending United Kingdom Patent Application number 0206852.6, filed Mar. 22, 2002.

### STATEMENT REGARDING FEDERALLY SPONSORED RESEARCH OR DEVELOPMENT

N/A

### BACKGROUND OF THE INVENTION

This invention relates to a data communications method. The invention also relates to a peripheral device configured to use the data communications method.

Host communications systems are commonly connected to peripheral devices. For example, a Portable Digital Assistant (PDA) may be connected to a Bluetooth device to allow wireless communications with other Bluetooth devices. Bluetooth is a computing and telecommunications industry specification that describes how mobile phones, computers and personal digital assistants (PDAs) can easily interconnect with each other, and with home and business telephones using a short-range wireless connection. Each Bluetooth device is equipped with an RF transceiver which transmits and receives in the previously-unused frequency band of 2.45 Ghz that is available globally (with some variation of bandwidth in different countries).

In certain applications, such as with the PDA example given above, the host communications system and/or the peripheral device is battery-powered. In such battery-powered systems which use serial/parallel bus communications, the peripheral device consumes power in order to maintain a state of readiness so that the host computer can send data to the peripheral. This state of readiness requires a certain amount of power to be used, mainly to maintain the peripheral's internal clocks that allow the reception of data from the host communications system.

### SUMMARY OF THE INVENTION

Objects and advantages of the invention will be set forth in part in the description that follows, and in part will be obvious from the description, or may be learned by practice of the invention. Additional objects and advantages of the invention may be realized and attained by means of the instrumentalities and combinations particularly pointed out in the appended claims.

According to one aspect of the present invention, there is provided a method of transferring data from a host communications device to a peripheral device over a data channel, the peripheral device including a receiver for processing received data, the method comprising: (i) monitoring the amount of data being transferred from the host communications device to the peripheral device; (ii) determining when the amount of data transferred is at, or below, a predetermined amount; (iii) disabling the receiver of the peripheral device in response to the amount of transferred data being at, or below, the predetermined amount; and (iv) re-enabling the receiver of the peripheral device when data is able to be transferred to the peripheral device.

Thus, the method enables reduced power consumption by disabling the reception of data by the peripheral device if no data is to be transmitted over the data channel, effectively putting the peripheral in a low-power mode. This can be done by disabling the clock signals within the peripheral device until such time when data is ready to be transmitted over the data channel.

The method may further comprise sending a command signal from the peripheral device to the host communications device when the amount of transferred data is at, or below, a predetermined amount, the host communications device being configured to stop sending further data in response to receiving the command signal.

The data channel may include a communications bus and a handshake line, the handshake line being used to transmit the command signal from the peripheral device to the host communications device to the peripheral device. The data channel may use a combined communications bus which includes a handshake line as part of its configuration.

In one exemplary embodiment, in an initial state, the step of determining when the amount of data transferred is at, or below, a predetermined amount is not performed until after a first predetermined time delay. Also, when it is determined that the amount of data being transferred is at, or below, the predetermined amount, the step of determining when the amount of data transferred is at, or below, a predetermined amount is repeated after a second predetermined time delay, the step of disabling the receiver being performed only if the amount of data being transferred remains at or below the predetermined amount. Following the step of disabling the receiver, the receiver of the peripheral device may remain disabled for a third predetermined time period, the step of re-enabling the receiver being performed only after the third predetermined time period has completed.

Preferably, the predetermined amount of data being transferred is zero.

The peripheral device as mentioned above may receive data using the RS232 protocol. Other serial/parallel data protocols could also utilize the presently disclosed methodology. The peripheral device can be a Bluetooth peripheral device.

According to a second aspect of the invention, there is provided a computer readable medium containing computer executable instructions for causing a processor to execute the steps of a method of transferring data from a host communications device to a peripheral device over a data channel, the peripheral device including a receiver for processing received data, the method comprising: (i) monitoring the amount of data being transferred from the host communications device to the peripheral device; (ii) determining when the amount of data being transferred is at, or below, a predetermined amount; (iii) disabling the receiver of the peripheral device in response to the amount of transferred data being at, or below, the predetermined amount; and (iv) re-enabling the receiver of the peripheral device when data is able to be transferred to the peripheral device.

According to a third aspect of the present invention, there is provided a peripheral device for receiving data from a host communications device over a data channel, the peripheral device comprising: a receiver for processing received data; and a controller arranged to (i) monitor the amount of data being received from the host communications device, (ii) determine when the amount of data being transferred is at, or below, a predetermined amount, (iii) disable the receiver in response to the amount of received data being at, or below, the predetermined amount; and (iv) re-enable the receiver when data is able to be transferred to the peripheral device.

The receiver can be re-enabled in response to the host communications device indicating that data is required to be transferred to the peripheral device. Alternatively, the peripheral device may periodically check whether data is able to be transferred from the host communications device. This may be done on a timed basis.

The controller can be further arranged to send a command signal to the host communications device when the amount of transferred data is at, or below, the predetermined threshold thereby to prevent further data from being sent from the host communications device.

The data channel of the peripheral device may in some embodiments further include a communications bus and a handshake line, the controller being arranged to (i) transmit a command signal over the handshake line to the data channel, and (ii) receive data over the communications bus.

The controller may be configured such that, in an initial state, it does not determine whether the amount of data being transferred is at, or below, a predetermined amount until after a first predetermined time delay. The controller may be configured such that, when it is determined that the amount of data being transferred is at, or below, the predetermined amount, the controller repeats this determination operation once again after a second predetermined time delay, the controller being configured to perform the disabling operation only if the amount of data being transferred remains at or below the predetermined amount after the second predetermined time delay. The controller can be configured to keep the receiver disabled for a third predetermined time delay and to re-enable the receiver only after the third predetermined time period has completed.

Preferably, the controller is configured such that the predetermined amount of data at which the receiving means is disabled is set to zero.

The accompanying drawings, which are incorporated in and constitute a part of this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

FIG. 1 is a block diagram of an exemplary communications system including a host communications device and a Bluetooth peripheral device in accordance with the present subject matter;

FIG. 2 is a more detailed block diagram of exemplary features of the communications system shown in FIG. 1; and

FIG. 3 is a flow chart showing exemplary steps in a method of data communications in accordance with the present subject matter.

### DETAILED DESCRIPTION OF THE PREFERRED EMBODIMENTS

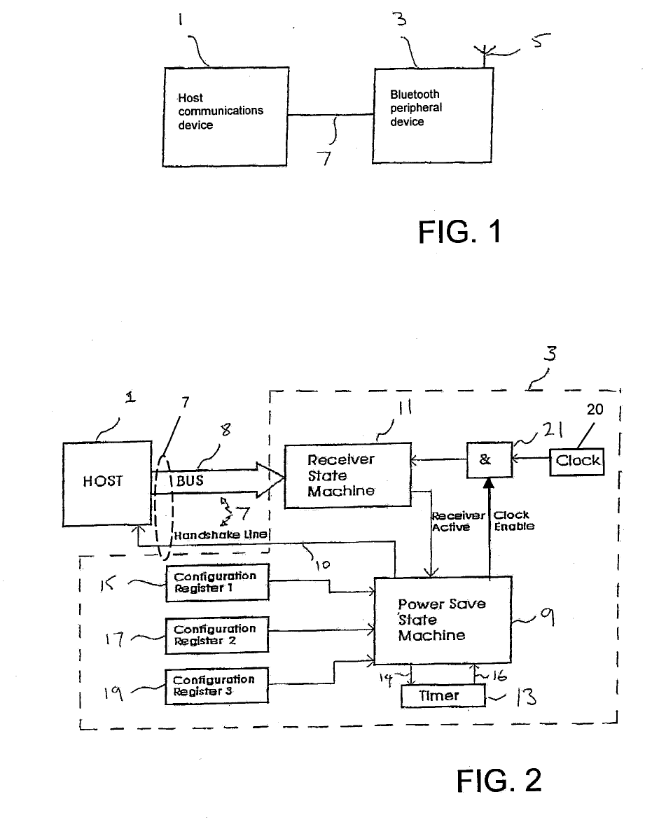

Referring to FIG. 1, an exemplary communications system in accordance with the presently disclosed technology comprises a host communications device 1 and a Bluetooth peripheral device 3. The host communications device 1 in this embodiment is a PDA (Personal Digital Assistant) and this term will be used throughout the remainder of this description. It is to be understood, however, that such use does not represent a limitation on the types of devices that may be used in the practice of the present invention. The invention, for example, may be used in a wireless local area network (WLAN) environment using the 802.11b protocol as well as other communication systems using other protocols. The Bluetooth peripheral device 3 has an antenna 5 attached thereto and is connected to the PDA 1 by means of a data channel 7. The Bluetooth peripheral device 3 enables the PDA 1 to communicate with remote data networks using the Bluetooth wireless protocol.

Referring now to FIG. 2, which is a more detailed diagram of exemplary features of the communications system shown in FIG. 1, the data channel 7 includes a data communications bus 8 and a handshake line 10. The data communications bus 8 is configured to communicate data between the PDA 1 and the Bluetooth peripheral device 3. Specifically, the data communications bus 8 is connected to a receiver state machine 11 that is arranged to receive data over the bus when a receiver clock 20 is enabled. The resultant receiver clock signal is applied to the receiver state machine 11 by means of an AND gate 21.

The central control element of the Bluetooth peripheral device 3 is a power save state machine 9. The power save state machine 9 receives a “receiver active” signal from the receiver state machine 11 when data is being received over data communications bus 8. The power save state machine 9 also outputs a “clock enable” signal to the AND gate 21 thereby to enable the receiver clock signal to be applied to the receiver state machine 11. Further, the power save state machine 9 outputs a signal on the handshake line 10 of the data channel 7. A timer 13 is connected to the power save state machine 9 by respective input and output lines 14, 16. The purpose of the “receiver active” and the “clock enable” signals, as well as the handshake line 10 and the timer input and output lines 14, 16 will be explained in greater detail below.

First, second and third configuration registers 15, 17, 19 are connected to the power save state machine 9. These configuration registers 15, 17, 19 contain respective first, second and third predetermined data values, the purpose of which will be more thoroughly discussed below.

The power save state machine 9 is configured to apply a signal to the handshake line 10 so as to indicate to the PDA 1 that data should or should not be sent to the Bluetooth peripheral device 3 over the data communications bus 8. The handshake signal on line 10 is asserted to indicate that the Bluetooth peripheral device 3 can receive data, and de-asserted to indicate that the Bluetooth peripheral device should not receive data. Latency is allowed when the de-asserted signal is applied to account for certain registers of the PDA 1 (e.g., first-in first-our (FIFO) registers) which empty data from their “stack” for a predetermined time period.

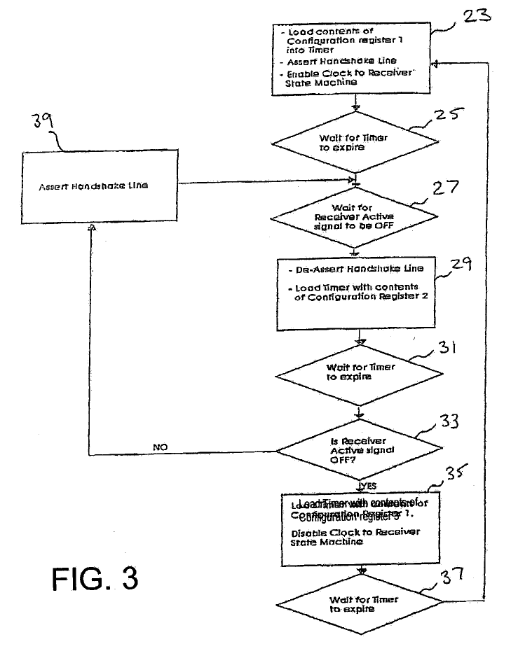

The power save state machine 9 operates according to a predetermined algorithm which will now be described in detail with reference to the flow chart of FIG. 3. It will be appreciated that the algorithm can readily be realized in a computer program which can be downloaded to a peripheral communications device, such as the Bluetooth device 3 described in this embodiment.

Referring now to FIG. 3, in an initial state 23, the power save state machine 9 loads a first predetermined data value, stored in first configuration register 15, into the timer 13 via input line 14. The handshake line 10 is asserted to indicate that data can be sent from the PDA 1 over the data communications bus 8. The clock is also enabled by applying a high “clock enable” signal to the AND gate 21. The resultant clock signal is applied to the receiver state machine 11. The first predetermined data value stored in the timer 13 decrements when the handshake line 10 is asserted. The time taken for the timer 13 to reach zero is appropriately set to equal the maximum amount of time taken for the PDA 1 to start transmitting available data after the handshake line 10 is asserted. Accordingly, any inherent time lag in the system is accounted for. Thus, in the next step 25, the timer 13 is allowed to expire before the next step 27 is entered. When the timer 13 expires, a signal is received by the power save state machine 9 on output line 16.

The data communications bus 8 is now able to communicate data to the Bluetooth peripheral device 3. In the next step 27, the power save state machine 9 monitors the receiver state machine 11 to see if data is being received from the PDA 1. Specifically, the power save state machine 9 monitors the “receiver active” signal from the receiver state machine 11, this signal being “high” if data is being received and “low” if zero data is being received (although a non-zero threshold could also be set). When the “receiver active” signal is “low”, the next step 29 is entered, during which the handshake line 10 is de-asserted and the power save state machine 9 loads a second predetermined value, stored in second configuration register 17, into the timer 13.

The de-assertion of the handshake line 10 indicates to the PDA 1 that no more data should be transmitted. However, as mentioned above, since FIFO registers of the PDA 1 may have to empty even after the handshake line 10 is de-asserted, latency has to be provided for in the system. This is provided by the second predetermined value stored in the timer 13. In step 31, the timer 13 decrements as before, and, in the next step 33, after the timer 13 has expired, the “receiver active” signal is once again monitored.

If the “receiver active” signal is “high” then the PDA 1 is still sending data to the Bluetooth peripheral device 3. Accordingly, in step 39, the handshake line 10 is asserted to enable the PDA 1 to continue sending data, and the power save state machine 9 waits for the “receiver active” signal to go “low” again.

If the “receiver active” signal is “low”, in step 35, the power save state machine 9 loads a third predetermined value from the third configuration register 19 to the timer 13. At the same time, the clock signal is disabled by sending a “low” clock enable signal to the AND gate 21. The time taken for the third predetermined value to decrement to zero in the timer 13 is the maximum time that the Bluetooth peripheral device 3 is permitted to remain in a “sleep” mode. This value is set to represent the maximum acceptable latency in transferring data from the PDA 1 to the Bluetooth peripheral device. In this step, the Bluetooth peripheral device 3 enters a low power mode since the clock signal is disabled and no data is received. Once the timer reaches zero, in step 37, the algorithm returns to the initial state 23 and the process repeats.

The exemplary method and system described above enables the Bluetooth peripheral device 3 to effectively enter an ultra-low power mode in which clock devices associated with data transfer can be disabled when no data is required to be transmitted. Data loss is prevented through the use of a hardware handshake mechanism that stops the host computer from sending data while the peripheral is in the low power mode. Latency in the PDA 1 responding to a change in handshake signals is provided.

As previously mentioned, the algorithm of FIG. 3 can be realized in a hardware state machine or in a software program. Indeed, a combination of hardware and software could be used. While a communications system using the RS232 protocol has been described, the method finds equal application in other serial and parallel data transfer protocols.

What is claimed is:

1. A method of transferring data from a host communications device to a peripheral device over a data channel, the peripheral device including a receiver for processing received data, the method comprising the steps of:
(i) monitoring the amount of data being transferred from a host communications device to a peripheral device over a data channel;
(ii) determining when the amount of data being transferred over the data channel is at, or below, a predetermined amount;
(iii) disabling a receiver within the peripheral device in response to a determination that the amount of transferred data is at, or below, the predetermined amount; and
(iv) re-enabling the receiver within the peripheral device when data is able to be transferred to the peripheral device.

2. A method according to claim 1, further comprising the steps of:
sending a command signal from the peripheral device to the host communications device when the amount of transferred data is at, or below, the predetermined amount, and
stopping the host communications device from sending further data in response to receiving the command signal.

3. A method according to claim 2, wherein the data channel includes a communications bus and a handshake line, the method further comprising the steps of:
applying a signal to the handshake line to transmit the command signal from the peripheral device to the host communications device; and
using the communications bus to send data from the host communications device to the peripheral device.

4. A method according to claim 1, further comprising the step of providing an initial first predetermined time delay prior to determining when the amount of data being transferred is at, or below, a predetermined amount.

5. A method according to claim 4, further comprising the steps of:
repeating, after a second predetermined time delay, the step of determining when the amount of data being transmitted is at, or below, a predetermined amount when it is previously determined that the amount of data being transferred is at, or below, the predetermined amount, and;
disabling the receiver within the peripheral device only if the amount of data being transferred remains at or below the predetermined amount.

6. A method according to claim 5, further comprising the step of maintaining the receiver in the peripheral device disabled for a third predetermined time period prior to re-enabling the receiver.

7. A method according to claim 1, wherein the predetermined amount of data being transferred is zero data.

8. A method according to claim 1, wherein the peripheral device receives data using the RS232 protocol.

9. A computer program embodied on a computer readable medium for managing the transfer of data from a host communications device to a peripheral device over a data channel, the peripheral device including a receiver, said program comprising:
computer readable instructions for monitoring the amount of data being transferred from a host communications device to a peripheral device over a data channel;
computer readable instructions for determining when the amount of data being transferred over the data channel is at, or below, a predetermined amount;
computer readable instructions for disabling a receiver within the peripheral device in response to a determination that the amount of transferred data is at, or below, the predetermined amount; and
computer readable instructions for re-enabling the receiver within the peripheral device when data is able to be transferred to the peripheral device.

10. A computer program according to claim 9 further comprising:
computer readable instructions for sending a command signal from the peripheral device to the host communications device when the amount of transferred data is at, or below, the predetermined amount, and
computer readable instructions for stopping the host communications device from sending further data in response to receiving the command signal.

11. A computer program according to claim 10 wherein the data channel includes a communications bus and a handshake line, the program further comprising:
computer readable instructions for applying a signal to the handshake line to transmit the command signal from the peripheral device to the host communications device; and
computer readable instructions for using the communications bus to send data from the host communications device to the peripheral device.

12. A computer program according to claim 9 further comprising:
computer readable instructions for repeating, after a predetermined time delay, the instructions to determine when the amount of data being transmitted is at, or below, a predetermined amount when it is previously determined that the amount of data being transferred is at, or below, the predetermined amount, and;
computer readable instructions for disabling the receiver within the peripheral device only if the amount of data being transferred remains at or below the predetermined amount.

13. A computer program according to claim 12 further comprising:
computer readable instructions for maintaining the receiver in the peripheral device disabled for a second predetermined time period prior to re-enabling the receiver.

14. A peripheral device for receiving data from a host communications device over a data channel, the peripheral device comprising:
a receiver for processing received data; and
a controller configured to:
(i) monitor the amount of data being transferred from the host communications device;
(ii) determine when the amount of data being transferred is at, or below, a predetermined amount,
(iii) disable the receiver in response to the amount of transferred data being at, or below, the predetermined amount; and
(iv) re-enable the receiver when data is able to be transferred to the peripheral device.

15. A peripheral device according to claim 14, wherein the controller is further configured to send a command signal to the host communications device when the amount of transferred data is at, or below, the predetermined amount thereby to prevent further data being sent from the host communications device.

16. A peripheral device according to claim 15, wherein the data channel comprises a communications bus and a handshake line, and wherein the controller is configured to:
(i) transmit the command signal over the handshake line of the data channel, and
(ii) receive data over the communications bus.

17. A peripheral device according to claim 14, wherein the controller is configured such that, in an initial state, it delays determining whether the amount of data being transferred is at, or below, the predetermined amount until after a predetermined time delay.

18. A peripheral device according to claim 17, wherein the controller is configured such that, when the controller determines that the amount of data being transferred is at, or below, the predetermined amount, the controller repeats the determination that the amount of data being transferred is at, or below, the predetermined amount once again after a second predetermined time delay, the controller being configured to disable the receiver only if the amount of data being transferred remains at or below the predetermined amount after the second predetermined time delay.

19. A peripheral device according to claim 18, wherein the controller is configured to keep the receiver disabled for a third predetermined time delay, and to re-enable the receiver only after the third predetermined time period has completed.

20. A peripheral device according to claim 14, wherein the controller is configured such that the predetermined amount of data being transferred at which the receiver is disabled is set to zero.
